(19) United States
(12) Patent Application Publication
(10) Pub. No.: US 2022/0107522 A1
(43) Pub. Date: Apr. 7, 2022

(54) POLYMER NETWORKED LIQUID CRYSTAL SMART WINDOW DEVICE AND METHODS OF MAKING THE SAME

(71) Applicant: NITTO DENKO CORPORATION, Osaka (JP)

(72) Inventor: Piotr Popov, San Diego, CA (US)

(21) Appl. No.: 17/423,567

(22) PCT Filed: Jan. 20, 2020
(86) PCT No.: PCT/US2020/014654

§ 371 Date: Jul. 16, 2021

Related U.S. Application Data
(60) Provisional application No. 62/795,488, filed on Jan. 22, 2019.

(51) Int. Cl. G02F 1/1334; G02F 1/1343; G02F 1/137; G02F 1/13; G02F 1/1341; E06B 9/24; E06B 3/663; E06B 3/67

(52) U.S. Cl. CPC G02F 1/13345; G02F 1/13439; G02F 1/13718; G02F 1/134309; G02F 1/1323; E06B 2009/2464; G02F 1/1341; E06B 9/24; E06B 3/66304; E06B 3/6722; G02F 2202/36; G02F 1/13706

(57) ABSTRACT

A polymer networked liquid crystal (PNLC) switchable light shutter with ultra-low power consumption is disclosed. A polymerizable mixture with a liquid crystal formulation and a polymerizable reactive mesogen composition, wherein the polymerizable reactive mesogen composition forms polymer networks and when in the presence of a zero-electric field the liquid crystals are in an optically opaque focal conic state is described.

### CROSS-REFERENCE TO RELATED APPLICATIONS

This application claims the benefit of U.S. Provisional Patent Application No. 62/795,488, filed Jan. 22, 2019, which is incorporated herein in its entirety.

### BACKGROUND

### Field

The present disclosure relates to a light shutter comprising a polymer networked liquid crystal which can be switched from an optically opaque focal conic state to an optically transparent state having a large viewing angle. Additionally, the light shutter has the ability to store electrical charges and discharge slowly allowing for power consumption on the order of μW/m² scale when electrically driven by short DC pulses.

### Description of Related Art

In the field of windows, smart windows are attractive alternatives to conventional mechanical shutters, blinds, or hydraulic methods of shading. Efforts have been made to optimize smart windows to control light waves (e.g. ultraviolet, visible and infrared light) from passing through windows. Such control may be to provide privacy, reduce heat from ambient sunlight, and control harmful effects of ultraviolet light. Currently, there are three main technologies for smart window applications: polymer dispersed liquid crystals (PDLCs), polymer stabilized cholesteric texture (PSCT) and metal oxide electrochromics (ECs).

PDLC light shutters involve phase separation of the nematic liquid crystal from a homogenous mixture of liquid crystal and polymer disposed between two parallel substrates with transparent electrodes. The phase separated nematic liquid crystals forms micro domains/droplets dispersed within a polymer matrix. In the off state, the liquid crystals contained within these micro droplets are randomly oriented, resulting in a mismatch of their refractive indexes between the polymer matrix and the liquid crystals resulting in an opaque (light scattered state). When an external electrical field is applied to the light shutter, the liquid crystals orient such that the refractive indexes between the polymer matrix and the liquid crystals match and a transparent state results.

One drawback of PDLC light shutters is the inherent haze caused by the refractive index mismatching, resulting in a narrow viewing angle in the transparent state. Furthermore, PDLCs require large and continuous voltages to maintain one of the optical states, resulting in increased costs.

ECs may be used for controlling the amount of light and/or heat passing through a window based on a user-controlled electrical potential that is applied across an optical stack of the electrochromic coating. The control provided by the electrochromic coating or material can reduce the amount of energy necessary to heat or cool a room, and it may provide privacy. For example, a clear state of the electrochromic coating or material having an optical transmission of about 60-80% can be switched to a darkened state having an optical transmission of between 0.1-10% where the energy flow into the room is limited and additional privacy is provided.

Several issues make current ECs undesirable for certain applications. Conventional solid-state ECs require thick electrochromic layers, for example 1 μm, to achieve a low percent transmission (% T) in the ON-state/dark state. The need for thick layers to achieve low % T leads to increased material consumption, increased processing time and slower production speed which all lead to increased manufacturing costs. This increase in manufacturing cost (about $100/m²), has limited the ECs window market to only commercial buildings.

PSCT light shutters are made from a composite of a cholesteric liquid crystal and a polymer. The mixture of cholesteric liquid crystals and polymer are sandwiched between two parallel substrates (e.g., glass and/or plastic plates or films) with transparent electrodes. PSCTs can operate in two modes: a normal mode and a bistable mode. In the normal mode, an external electrical voltage is applied, the PSCT material switches from one optical state to another (e.g., an opaque focal conic state to a transparent homeotropic or planar state or vice versa). However, the problem with the normal state is that a voltage must be applied continuously to sustain one of the optical states, resulting in the consumption of a lot of energy when the voltage must be applied for prolonged periods. The bistable mode has two stable states in the absence of an applied voltage. While a bistable light shutter is a very attractive concept, challenges still exist with maintaining the delicate stability of both optical states within a wide range of operating conditions and especially when external conditions change rapidly, for example due to rapid variations of temperature and temperature gradients across the area of the device. Bistable-type light shutters also have very strict requirements related to concentrations of components used in liquid crystal and polymer formulations and strict requirements related to variations in the manufacturing process.

Therefore, there remains a need for a light shutter having low power consumption (e.g., capable of battery powering), high haze in the scattering state, wide viewing angles in the transparent state, and with good stability across a wide range of operating conditions.

### SUMMARY OF THE DISCLOSURE

The current disclosure includes a polymer networked liquid crystal device that may be useful for functions such as a light shutter for a window. In some embodiments, the light shutters described herein may comprise a pair of opposing transparent electrodes. In some embodiments, the opposing transparent electrodes may define an electrode plane. In some embodiments, the light shutter may comprise a polymer composite comprising a liquid crystal and a polymer. In some embodiments, the polymer may be in the form of a polymer network, such as a network of polymer fibers. In some embodiments, the light shutter comprising the polymer composite may comprise liquid crystals in a focal conic configuration. In some embodiments, the polymer composite may comprise domains formed by polymer networks. In some embodiments, the polymer networks can align perpendicular to the electrode plane. In some embodiments, the polymer network may be disposed between the opposing transparent electrodes. In some embodiments, the polymer network may be in electrical communication with the opposing transparent electrodes. In some embodiments, the application of an electric field to the polymer network may switch the focal conic state liquid crystals to a homeotropically aligned transparent state liquid crystals. In some embodiments, the polymer network may comprise at least one liquid crystal compound. In some embodiments, the polymer network may comprise a chiral dopant. In some embodiments, the polymer network may comprise a reactive mesogen composition. In some embodiments, the reactive mesogen composition may comprise at least one reactive mesogen. In some embodiments, the reactive mesogen composition may comprise at least one polymerizable monomer. In some embodiments, the reactive mesogen composition may comprise a photo-initiator. In some embodiments, the at least one liquid crystal compound and the chiral dopant form cholesteric liquid crystals. In some embodiments, the cholesteric liquid crystals may have cholesteric pitch of about 0.38 μm to about half of the length of the dimension between the pair of opposing transparent electrodes, for example 5 μm in 10 μm cell gap. In some embodiments, the light shutter may further comprise a power source in electrical communication with the transparent electrodes. In some embodiments, the light shutter may further comprise at least one alignment layer. In some embodiments, the light shutter may further comprise at least one dielectric layer. In some embodiments, the at least one dielectric layer may comprise a transparent inorganic material. Some embodiments include a spacer in the alignment layer or the dielectric layer. In some embodiments, the polymer composite further comprises ion-trapping nanoparticles. In some embodiments, the polymer network further comprises ion-trapping nanoparticles. In some examples, the ion-trapping nanoparticles comprise NiO and/or TiO₂. The light shutters described herein can be useful for the control of ultraviolet light, visible light and infrared light. In some embodiments, the light shutters described herein can be useful for providing privacy, reducing heat from ambient sunlight, and controlling the harmful effects of ultraviolet light.

Some embodiments include a light shutter which has an RC time constant (τ) of about 60 minutes. In some embodiments, the light shutter may maintain a transparent state due to periodic application of opposite polarity DC pulses. In some embodiments, the light shutter consumes about 0.037 W/m² at 3 V/μm below 60 Hz of AC driving signal. In some embodiments, the light shutter maintains a transparent state by an external electric field. In some embodiments, the light shutter maintains a transparent state for at least about 10 minutes, at least about 20 minutes, at least about 30 minutes, up to 40 minutes, or more, with an internally stored electric field. In some embodiments, the liquid crystal component is a compound with positive dielectric anisotropy. Some embodiments include a light shutter, wherein the light shutter functions as a slow discharge capacitor. In some embodiments, the concentration of the at least one reactive mesogen is between 0.1 wt % to about 40 wt %. In some embodiments, the amount of voltage sufficient to effect transparency is less than 3 V/μm at a frequency below 60 Hz AC.

Some embodiments include a method for making a light shutter. The method may comprise: disposing at least one reactive mesogen, at least one liquid crystal compound, a chiral dopant and a photo-initiator in an uncured polymer composite: polymerizing the polymer composite in the presence of an external electrical field in the range of about 50 mV/μm to about 50 V/μm at 60 Hz to form a polymer network, wherein the at least one liquid crystal compound and the chiral dopant form cholesteric liquid crystals; and removing the external electrical field after curing, wherein the cholesteric liquid crystal re-orientate to a focal conic optical scattering state. In some embodiments, the polymerization of the reactive mesogen includes forming polymer networks within the cured liquid crystal and polymer composite. In some embodiments, the forming of the polymer networks includes aligning the networks parallel to the applied external electrical field. The light shutter of the present disclosure may be in accordance with any of the embodiments as describe herein.

These and other embodiments are described in greater detail below.

### BRIEF DESCRIPTION OF THE DRAWINGS

FIG. 1A Is a cross section of the light shutter depicting the light shutter in an optically transparent state in accordance with the concepts of the current disclosure.

FIG. 1B Is a cross section of the light shutter depicting the light shutter in an optically opaque focal conic state in accordance with the concepts of the current disclosure.

FIG. 2 Is a graph representing the self-discharge of a light shutter described herein and its transition from transparent to opaque optical states.

FIG. 3 Is a graph representing the electrical driving scheme with intermittent DC pulses of reversed polarity for ultra-low power consumption of a light shutter described herein.

FIG. 4 Is a photograph of a light shutter device, described herein, in its opaque and transparent optical states with no external power supplied.

FIG. 5 Is a graph depicting the haze level measurement of a light shutter device described herein.

FIG. 6 Is a graph representing the measurement of applied AC voltage and resulting electric current necessary to determine power consumption of a light shutter device described herein.

### DETAILED DESCRIPTION

Some embodiments of the present disclosure include a polymer networked liquid crystal light shutter, which may be used in window type applications for energy efficiency and privacy. The light shutters of the present disclosure can be switched between an opaque light scattering state to a transparent state by the application of an electromagnetic or electric field. Some light shutters may require no electric field when in the opaque light scattering state. Some embodiments include a light shutter that operates as a slow discharge capacitor, when in the transparent state, requiring only short reverse polarity DC pulses to maintain the transparent state applied with a periodicity of 1 second, or preferably 1 minute or more preferably about 1 per hour. Therefore, the light shutter of the present disclosure is energy-saving.

The term “transparent” as used herein, refers to, for example, structures that do not absorb a significant amount of visible light radiation, do not reflect a significant amount of visible light radiation, or do not scatter a significant amount of visible light radiation.

The term “cholesteric pitch” as used herein, refers to the distance over which the cholesteric liquid crystal (CLC) molecules rotate by a full 360° around an orthogonal axis known as helical axis.

The term “polymer composite” is a term of art, as used herein refers to a viscous composition or mixture of at least one reactive mesogen, at least one liquid crystal compound, a chiral dopant, and photo-initiator[s]. The polymer composite may also contain solvents, ion-trapping nanoparticles, additional polymerizable monomers such as crosslinkers, and other functional components.

The current disclosure includes a light shutter comprising a pair of opposing transparent electrodes. In some embodiments, the opposing transparent electrodes may define an electrode plane. Some embodiments include a light shutter, wherein the light shutter may comprise a polymer network formed from a polymer composite. In some embodiments, the polymer network may comprise liquid crystals in a focal conic configuration. In some embodiments, the liquid crystal and polymer composite may comprise domains formed by a polymer network. In some embodiments, the polymer network may align perpendicular to the transparent electrode plane. In some embodiments, the polymer network may be disposed between the transparent electrodes. In some embodiments, the polymer network may be in electrical communication with the transparent electrodes. In some embodiments, the polymer network may comprise at least one liquid crystal compound. In some embodiments, the polymer network may comprise a chiral dopant. In some embodiments, the liquid crystal and polymer composite may comprise a reactive mesogen composition. In some embodiments, the application of an electric field to the liquid crystal and polymer composite may switch the focal conic state of liquid crystals to a homeotropically aligned transparent state of the liquid crystals. In some embodiments, the light shutter may be indefinitely maintained in an optically opaque focal conic state when in a zero-electric field.

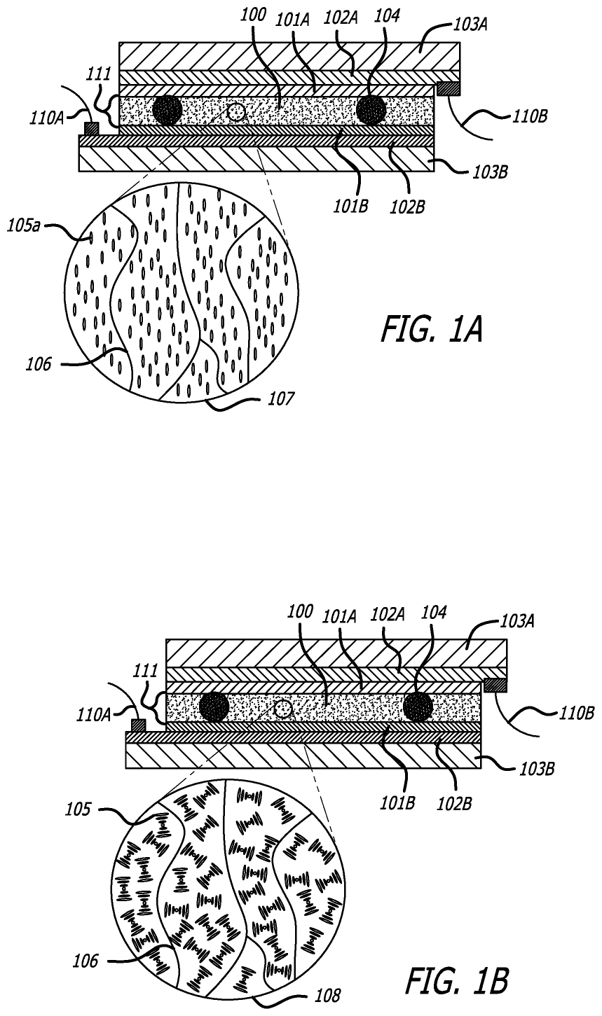

The light shutter includes structures that are electrically switched between an opaque state and a transparent state. In the transparent state, the liquid crystals are homeotropically aligned and therefore do not scatter light (see 107 in FIG. 1A). In the opaque state, the liquid crystals scatter light due to their helically twisted focal conic domains with randomly oriented axes. This random orientation of cholesteric liquid crystal domains is known as a focal conic state configuration (see 108 in FIG. 1B).

Referring to FIGS. 1A and 1B, the illustrative first embodiment of the light shutter of the present disclosure is depicted. The light shutter structure generally comprises a polymer network, such as polymer composite layer 100, interposed between a pair of opposing transparent electrodes, such as electrodes 102A and 102B, defining an electrode plane, which are supported by a pair of substantially transparent substrates, such as substrates 103A and 103B, each comprising an internal and external surface. A plurality of spacers, such as spacers 104, may be present within the polymer network to help maintain a cell gap, such as cell gap 111, between the opposing transparent electrodes. The light shutter can further comprise alignment layers, such as alignment layers 101A and 1018. In some embodiments, the light shutter further comprises dielectric layers, such as layers 101A and 1018. Layers 101 may represent an alignment layer in embodiments where there is an alignment layer, or they may represent a dielectric layer in embodiments where there is no alignment layer but rather a dielectric layer. In some embodiments, the alignment layer can function as a dielectric layer. Attached to the electrode layer are electrical lead wires 110A and 110B, which are used to connect the light shutter to an external power supply.

In some embodiments, the pair of opposing transparent electrodes are individually disposed upon the substantially transparent substrates. Any suitable transparent substrate may be selected. Some non-limiting examples of substrates include glass, and polymer films. Typical polymer films include films made of polyolefin, polyester, polyethylene terephthalate, polyvinyl chloride, polyvinyl fluoride, polyvinylidene difluoride, polyvinyl butyral, polyacrylate, polycarbonate, polyurethane, etc., and combinations thereof.

In some embodiments, the light shutter comprises a pair of opposing transparent electrodes. The pair of opposing transparent electrodes may comprise an indium tin oxide (ITO), a fluorine doped tin oxide (FTO), a poly(3,4-ethylenedioxythiophene) polystyrene sulfonate (PEDOT:PSS), a silver oxide, a zinc oxide, or other transparent conductive polymer or like film coating. Chemical vacuum deposition, chemical vapor deposition, evaporation, sputtering or other suitable coating techniques may be used for applying electrodes on substrate. In some embodiments, the substrate and electrode are provided in a single, commercially available construct.

Electrical lead wires, such as lead wires 110, may be attached to the electrodes. An external voltage source may be connected to the electrical leads to switch the light shutter from an opaque focal conic state to a transparent state. The external voltage source may also be used to pulse an electrical field to help maintain the optically transparent state by recharging the light shutter. The voltage source may be an AC voltage source. The voltage source may be an AC-DC inverter and a battery. In some embodiments, the voltage source may be a DC battery, such as thin cell.

In some embodiments, the light shutter comprises spacers, such as spacers 104. In some embodiments, the spacers may be incorporated into the alignment layer. In some cases, the spacers may be incorporated into the dielectric layer. In some examples, the spacers may be incorporated into the liquid crystal and polymer composite.

The present disclosure may include any suitable spacer. In some embodiments, the spacer may comprise NanoMicro HT100 microsphere spacers. In other embodiments, the spacer may comprise Sekisui SP210 spacers. Any suitable size may be selected for the spacer, which is generally measured by its diameter. In some embodiments, the spacer has a size of about 1 μm to about 20 μm, about 1 μm to about 2 μm, about 2 μm to about 3 μm, about 3 μm to about 4 μm, about 4 μm to about 5 μm, about 5 μm to about 6 μm, about 6 μm to about 7 μm, about 7 μm to about 8 μm, about 8 μm to about 9 μm, about 9 μm to about 10 μm, about 10 μm to about 11 μm, about 11 μm to about 12 μm, about 12 μm to about 13 μm, about 13 μm to about 14 μm, about 14 μm to about 15 μm, about 15 μm to about 16 μm, about 16 μm to about 17 μm, about 17 μm to about 18 μm, about 18 μm to about 19 μm, about 19 μm to about 20 μm, or about 10 μm.

In some embodiments, the alignment layer, the dielectric layer, or the liquid crystal and polymer composite of the present disclosure may include any appropriate amount of the spacer. In some embodiments, the spacer constitutes a weight percentage of about 0.1 wt % to about 1 wt %, about 0.1 wt % to about 0.2 wt %, about 0.2 wt % to about 0.3 wt %, about 0.3 wt % to about 0.4 wt %, about 0.4 wt % to about 0.5 wt %, about 0.5 wt % to about 0.6 wt %, about 0.6 wt % to about 0.7 wt %, about 0.7 wt % to about 0.8 wt %, about 0.8 wt % to about 0.9 wt %, about 0.9 wt % to about 1 wt %, or about 0.25 wt % relative to the total weight of the alignment layer, the dielectric layer, or the liquid crystal and polymer composite.

In some embodiments, the light shutter comprises a liquid crystal and polymer composite, 100. The polymer composite may comprise at least one liquid crystal compound and a chiral dopant. In some embodiments, the liquid crystal compound may comprise a nematic liquid crystal material. In some embodiments, the liquid crystal compound may comprise a positive dielectric liquid crystal compound. In some embodiments, the liquid crystal compound and the chiral dopant may form cholesteric liquid crystals. Some non-limited examples of liquid crystal compounds that may be used in the present light shutter include MLC-2109, MLC-2125, MLC-2132, MLC-2133, MCL-2134 MLC-15600-000, MLC-15600-100, MLC-3003, MLC-3012 and MLC-3016 (Merck, Germany). The concentration of the liquid crystal compound can be calculated by subtracting the total amount of chiral dopant[s], reactive mesogen[s], and the UV photo-initiator[s] from 100. The wt % of the liquid crystal compound(s) can be in the range of about 50 wt % to about 99 wt % of the total weight of the polymer composite, or about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, about 95 wt % to about 99 wt %, about 52 wt %, about 53 wt %, about 54 wt %, about 71 wt %, about 72 wt %, about 73 wt %, about 74 wt %, about 82 wt %, about 83 wt %, about 84 wt %, about 85 wt %, about 86 wt %, about 87 wt %, about 88 wt %, or any wt % in a range bounded by these values.

In some embodiments, the liquid crystal and polymer composite can comprise a chiral dopant. The chiral dopant and the liquid crystal compound(s) may combine to form cholesteric liquid crystals. In some embodiments, the cholesteric liquid crystals may have a cholesteric pitch of about 0.38 μm up to about half of the length of dimension between the pair of opposing transparent electrodes. The cholesteric pitch (p) can be calculated by using the equation:

$$p = \frac{1}{c \cdot HTP}$$

wherein c is the concentration of the chiral dopant, HTP is the helical twisting power of the chiral dopant in the liquid crystal compound, this number is dependent on the chiral dopant used and in which liquid crystal compound the chiral dopant is mixed, thus for a R-811 with an HTP of about 10 μm⁻¹ in MLC-2132 and c is 5 wt % the p would be about 2 μm. In some embodiments, the cholesteric liquid crystals form focal conic domains with a cholesteric pitch in the range of about 0.78 μm to about half of the length of the cell gap. Some examples of chiral dopants that may be used include, but are not limited to, R-811, S-811, R-1011, S-1011, R5011 and 55011 (Merck, Germany).

In some embodiments, the cholesteric liquid crystals may have a cholesteric pitch of about 0.1 μm to about 5 μm, about 0.1 μm to about 0.2 μm, about 0.2 μm to about 0.4 μm, about 0.4 μm to about 0.6 μm, about 0.6 μm to about 0.8 μm, about 0.8 μm to about 1 μm, about 1 μm to about 2 μm, about 2 μm to about 3 μm, about 3 μm to about 4 μm, about 4 μm to about 5 μm, about 0.38 μm, about 0.78 μm, about 5 μm, or any pitch in a range bounded by any of these values.

In some embodiments, the chiral dopant may comprise a single enantiomer, or may comprise a pair of enantiomers. Any suitable amount of the chiral dopant may be employed, including ranges between 0.1 wt % to about 10 wt %, about 1 wt % to about 10 wt %, about 2 wt % to about 9 wt %, about 3 wt % to about 8 wt %, about 4 wt % to about 7 wt %, about 5 wt % to about 6 wt %, about 7 wt % to 9 wt %, about 1 wt %, about 2 wt %, about 3 wt %, about 4 wt %, about 5 wt %, about 6 wt %, about 7 wt %, about 7.8 wt %, about 8 wt %, about 8.5 wt %, about 9 wt %, about 10 wt %, or any wt % in a range bounded by any of these values.

In some embodiments, the liquid crystal and polymer composite comprises a reactive mesogen composition. In some embodiments, the reactive mesogen composition may comprise at least one reactive mesogen. In some embodiments, the reactive mesogen composition may comprise at least one polymerizable monomer. In some embodiments, the reactive mesogen composition may comprise a photo-initiator. In some embodiments, the at least one reactive mesogen may be LC242 (Millipore Sigma). In some embodiments, the at least one reactive mesogen can be RM 257 (Millipore Sigma). The choices of reactive mesogen or polymerizable monomer is not particularly limited and one skilled in the art can determine any suitable reactive mesogen or polymerizable monomer.

In some embodiments, the reactive mesogen composition may comprise the polymer network. During polymerization, UV radiation and an external electrical field are applied to the liquid crystal cell, and the at least one reactive mesogen combined with the photo-initiator forms polymer networks. The external electrical field helps homeotropically align the polymer fibers that constitute the polymer network. The application of the external electrical field also facilitates unwinding of the liquid crystal's chiral helix, thus ensuring vertical alignment of the liquid crystals and the polymer network to the electrode plane. The concentration of the reactive mesogen(s) is in the range of about 0.1 wt % up to a critical volume concentration. The critical volume concentration is the concentration of the reactive mesogen(s) wherein the cholesteric liquid crystals will no longer relax from an optically transparent homeotropic state to a cholesteric helical state once the external and/or internal electrical field applied during polymerization is removed. If the reactive mesogen(s) exceeds the critical concentration the cholesteric liquid crystals will remain in the helically unwound state, unable to return to their focal conic state after polymerization, rendering the light shutter held in an optically transparent state. The critical volume concentration is the concentration of the reactive mesogen(s) necessary to ensure that after curing in the homeotropic optically transparent state, the cholesteric liquid crystals may return to their focal conic state with the removal of the external (and internal) electric field. The critical volume concentration can be calculated using the equation C=2π³R²/p², wherein C is the concentration of the reactive mesogen(s); R is the average cross-section radius of polymer fibers; and p is the cholesteric pitch length of the liquid crystals.

The wt % of the reactive mesogen(s) can be in the range of 0.1 wt % to about 40 wt % of the total weight of the liquid crystal and polymer composite. In some embodiments, the reactive mesogen(s) can have a concentration between about 1 wt % to about 35 wt, about 4 wt % to about 15 wt %, about 1 wt %, about 1 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 1 wt %, about 2 wt %, about 3 wt %, about 4 wt %, about 4.6 wt %, about 4.7 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, or any wt % in a range bounded by any of these values.

In some embodiments, the liquid crystal and polymer composite may further comprise a photo-initiator. In some embodiments, the photo-initiator may be an Ultra Violet (UV) photo-initiator. In some embodiments, the UV photo-initiator may comprise IrgaCure® 651 (BASF Chemical Co., Ludwigshafen, Germany). The selection of an initiator is not particularly limited; the initiator can be an UV or a heat activated initiator, etc., and one skilled in the art could choose an appropriate initiator depending on process conditions and application of the light shutter.

The weight percentage (wt %) of the UV photo-initiator is the wt % with respect to the total weight of the reactive mesogen(s), thus 1 wt % refers to 1% of the total amount of the reactive mesogen(s). For example, if the UV photo-initiator is 1 wt % and the reactive mesogen(s) is 4.7 wt % then the UV photo-initiator is 1% of the 4.7 wt %, which is about 0.047 wt % of the total weight of the precursor formulation. The wt % of the UV photo-initiator can be in the range of about 0.035 wt % to about 5 wt %, about 0.03 wt % to about 4 wt %, about 0.035 to about 3 wt %, about 0.4 wt % to about 2 wt %, about 0.5 to about 1 wt %, about 0.04 wt % to about 0.05 wt %, about 0.046 wt %, about 0.047 wt %, about 0.1 wt %, about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.85 wt %, about 0.9 wt %, about 0.95 wt %, about 1 wt %, about 2 wt %, about 3 wt %, about 4 wt %, about 5 wt %, or any wt % in a range bound by any of the values above.

In some embodiments, the light shutter may further comprise at least one alignment layer. In some embodiments, the alignment layer[s] may comprise a polyimide, polyvinyl alcohol, poly(methyl methacrylate) (PMMA) and/or combinations thereof. In some embodiments, the alignment layer may comprise SE-5661 (Nissan Chemicals, Tokyo, Japan). In some embodiments, the alignment of the liquid crystal formulation may be provided by polymer sustained alignment due to the formed polymer network and polymer surface structures during curing under an applied electrical field.

In some embodiments, the light shutter may further comprise at least one dielectric layer. The dielectric layer may comprise a transparent inorganic material. One skilled in the art could select any suitable dielectric material which falls in the scope of the present disclosure. The selection and variation of specific device components may be decided without departing from the described ideas herein. In some embodiments, the dielectric layer may comprise a silicon oxide (SiOₓ). In another embodiment, the dielectric layer may comprise aluminum oxide (Al₂O₃).

The light shutter of the present disclosure may have alignment and/or dielectric layer[s] of any suitable thickness. In some embodiments, the alignment layer[s] and/or dielectric layer[s] may be about 1 nm to about 1 μm, about 1 nm to about 50 nm, about 50 nm to about 100 nm, about 100 nm to about 200 nm, about 200 nm to about 300 nm, about 300 nm to about 400 nm, about 400 nm to about 500 nm, about 500 nm to about 600 nm, about 600 nm to about 700 nm, about 700 nm to about 800 nm, about 800 nm to about 900 μm, about 900 nm to about 1 μm, about 50 nm, 100 nm, about 150 nm, about 200 nm, or any thickness in a range bounded by any of these values.

In some embodiments, the light shutter may be driven from a focal conic state to a transparent state by a direct current (DC) without image sticking. When the light shutter of the present disclosure is operated in the DC mode, it is recommended to apply pulses of opposite polarity to further lower the likelihood of undesired image sticking visual phenomena. FIG. 3 is a graph depicting a driving scheme to maintain a transparent optical state by applying periodic DC pulses of reversed polarity.

In some embodiments, the light shutter may operate as a slow discharge capacitor.

In some embodiments, the light shutter may maintain its transparent state for up to 40 minutes with a stored internal electric field. In some embodiments, the light shutter may maintain its transparent state for up to 60 minutes with a stored internal electric field. In some embodiments, the light shutter may maintain its transparent state for up to 90 minutes with a stored internal electric field.

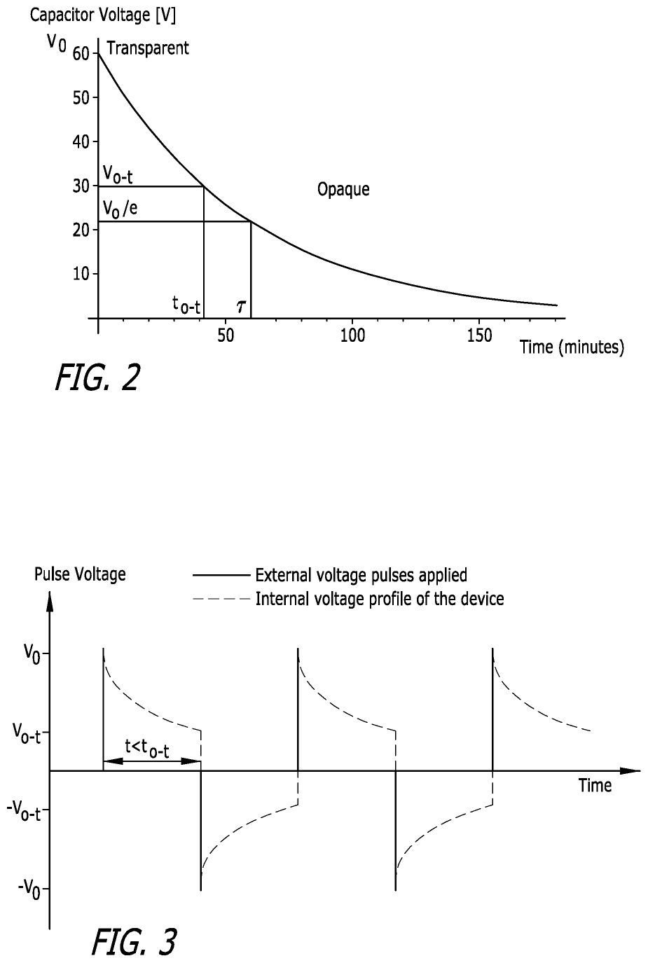

In some embodiments, the light shutter may have an RC time constant (τ) of about 50-70 minutes or about 60 minutes. In some embodiments, the light shutter may maintain a transparent state with short DC pulses of reversed polarity. FIG. 2 is a graphical representation of the performance of a device, with τ=60 minutes, in the transparent state while utilizing an internal stored electrical field: Vₒ₋ₜ=30 V is the minimum voltage required to switch the device from the opaque state to its transparent state: V₀=60 V, is the initial charging voltage (which is two times higher than Vₒ₋ₜ): and tₒ₋ₜ is the time the device maintains transparency with the internally stored electric field. Thus, a device with a τ=60 minutes, will require a short DC pulse approximately every 40 minutes to maintain the transparent optical state. FIG. 3 is a graph that represents the opposite polarity DC pulsing in a device with a τ=60 minutes. As long as the DC pulses are applied within an interval of time shorter than tₒ₋ₜ, the device will maintain its transparent state.

The light shutter of the present disclosure can consume about 0.037 W/m² of power at 3 V/μm of AC electrical field at frequencies below 60 Hz in a device with 10 μm cell gap. When the light shutter is powered by intermittent opposite polarity DC electric field pulses, the power consumption can be effectively lowered to the μW/m² range.

In some embodiments, the liquid crystal compound may be a positive dielectric anisotropy material. The reactive mesogen composition may comprise at least one reactive mesogen.

In some embodiments, the liquid crystal and polymer composite is disposed within the defined electrode plane formed between and in electrical communication with the pair of opposing transparent electrodes. In the case where there is a physical contact between the electrodes and the functionalized alignment layers or dielectric layers, the polymer composite precursor composition is in physical contact and electrical communication with the alignment layers or dielectric layers. In some embodiments, the polymer composite comprises the reactive mesogen composition. In some embodiments, the reactive mesogen composition comprises at least one reactive mesogen and a photo-initiator. In some embodiments, the liquid crystal and polymer composite is cured under ultraviolet radiation in the presence of an external electrical field. The external electrical field facilitates the vertical alignment, with respect to the electrode plane, and formation of the polymer network, while also aligning the liquid crystal material in a transparent homeotropic state during curing (see 107 in FIG. 1A). In some embodiments, the at least one reactive mesogen and the photo-initiator can form a polymer network, (see 106 in FIGS. 1A & 1B), that aligns substantially vertically in relation to the pair of opposing partially transparent electrodes (see 102A and 102B in FIGS. 1A & 1B). In some embodiments, the light shutter can be in an optically focal conic scattering state in a zero-electric field while the polymer network is vertically aligned (see 108 in FIG. 1B). Some embodiments include a light shutter wherein the amount of voltage that is sufficient to effect transparency may be less than 3 V/μm at frequencies below 60 Hz.

Some embodiments include a light shutter, wherein the light shutter further comprises an alignment layer (see 101A and 101B in FIGS. 1A & 1B). The alignment layer is not particularly limited and any suitable alignment layer may be employed. In some embodiments, the alignment layer may comprise a polyimide. The polyimide alignment layer may be commercially available, for example, SE-6551 (Nissan Chemical Corp., Tokyo, Japan). In other embodiments, the light shutter may comprise a dielectric layer. In other embodiments, there is no alignment layer, but rather a dielectric layer. In some embodiments the alignment layer can have a dual role where it functions as both an alignment layer and as a dielectric layer. Thus element 101 in FIGS. 1A & 1B can be an alignment layer or a dielectric layer. Other suitable alignment/dielectric layers include SE-4811, SiOₓ, and Al₂O₃.

In some embodiments, the precursor liquid crystal/reactive mesogen mixture further comprises ion-trapping nanoparticles. In some embodiments, the ion-trapping nanoparticles comprise NiO. In some examples, the ion-trapping nanoparticles comprise TiO₂. In some embodiments, the ion-trapping nanoparticles comprise NiO and TiO₂. Any suitable amount of the ion-trapping nanoparticles may be employed. In some embodiments, the total amount of ion-trapping nanoparticles may be from about 0.01 wt % to about 2 wt % of the total weight of the precursor liquid crystal/reactive mesogen mixture. In some embodiments, the nanoparticles are present in about 0.01 wt % to about 0.05 wt %, about 0.05 wt % to about 0.1 wt %, about 0.1 wt % to about 0.25 wt %, about 0.25 wt % to about 0.5 wt %, about 0.5 wt % to about 0.75 wt %, about 0.75 wt % to about 1 wt %, about 1 wt % to about 1.25 wt %, about 1.25 wt % to about 1.5 wt %, about 1.5 wt % to about 1.75 wt %, about 1.75 wt % to about 2 wt %, or about 0.05 wt %, about 0.1 wt %, or any weight percentage bound by any of these ranges.

In some embodiments, the size of the ion-trapping nanoparticles may be from about 1 nm to about 100 nm. The size of the ion-trapping nanoparticles is generally measured by their diameter. The size of the ion-trapping nanoparticles may be about 1 nm to about 10 nm, about 1 nm to about 2 nm, about 2 nm to about 3 nm, about 3 nm to about 4 nm, about 4 nm to about 5 nm, about 5 nm to about 6 nm, about 6 nm to about 7 nm, about 7 nm to about 8 nm, about 8 nm to about 9 nm, about 9 nm to about 10 nm, about 10 nm to about 25 nm, about 25 nm to about 50 nm, about 50 nm to about 75 nm, about 75 nm to about 100 nm, or about 1 nm, about 5 nm, about 10 nm, or any size in a range bounded by any of these values.

In some embodiments, the light shutter can have an RC time constant of about 50-70 minutes or about 60 minutes. The discharge time constant can be calculated by the formula τ=R*C, wherein τ is the time constant, R is the resistance of the entire device and C is the capacitance of the device. It is believed that the optional alignment layer functions as a dielectric layer in the current disclosure. The dielectric layer prevents the device from electrical shorts and may influence the stability of the optical states when the device is sufficiently charged. It has been discovered that when a certain polyimide alignment layer, such as SE-6551 (Nissan), is present, the transparent state can be held for up to 40 minutes without a continuous power supply. It is believed that the light shutter of the current disclosure stores an internal electric field when the applied external electric field is switched off and slowly discharges over a period controlled by the RC time constant. It is believed that the light shutter is operating similarly to a slow discharge capacitor with flat electrode configuration. The light shutter of the current disclosure may maintain its optically transparent state for up to 40 minutes with the stored internal electric field. This storage of an internal electrical field and slow discharge rate enables the light shutter to consume ultra-low power. The light shutter can maintain an optically transparent state with an internally stored electric field, and the light shutter only requires short DC pulses of opposite polarity to maintain the transparent state. The light shutter may be switched from the transparent state to an opaque focal conic state simply by electrically shorting the device (wherein the switching occurs within a millisecond), or by allowing the internally stored electrical field to discharge completely. Thus, the light shutter only requires short periodic electrical pulses to operate in the transparent state. The light shutter does not require any electrical field to remain indefinitely in the opaque focal conic state. In some embodiments, the light shutter can operate with an AC power source. In some embodiments, the light shutter can operate with a DC power source. In some embodiments, the light shutter can comprise a slow discharge capacitor. In some embodiments, the light shutter with a cell gap of 10 μm consumes about 0.02-0.06 W/m², about 0.03-0.04 W/m², or about 0.037 W/m² of power at 3 Wpm at frequencies below 60 Hz. This measurement of power consumption correlates to when the light shutter is operated with an AC field and the power consumption can be much lower when operated with short DC pulses. When the light shutter is powered by intermittent reverse polarity direct current (DC) pulses, the time-averaged effective power consumption can be in the μW/m² scale.

In some embodiments, the light shutters of the present disclosure are highly transparent in the charged state. In some examples, the haze of the transparent state is less than about 5%. In some embodiments, the haze in the transparent state may be about 0.1% to about 0.5%, about 0.1% to about 0.5%, about 0.5% to about 1%, about 1% to about 2%, about 2% to about 3%, about 3% to about 4%, about 4% to about 5%, or about 2%, about 4%, or any haze in a range bounded by any of these values.

In some embodiments, the light shutters of the present disclosure are highly opaque in the uncharged, or default, state. In some examples, the haze of the opaque state is more than about 80%. In some embodiments, the haze in the opaque state may be about 80% to about 82%, about 82% to about 84%, about 84% to about 86%, about 86% to about 88%, about 88% to about 90%, about 90% to about 92%, about 92% to about 94%, about 94% to about 96%, about 96% to about 98%, about 98% to about 100%, or about 85%, about 86%, about 86.5%, about 87% about 87.3%, about 88 wt %, or any haze in a range bounded by any of these values.

Some embodiments include a method for making a light shutter of the present disclosure. The method comprises: disposing a reactive mesogen composition, at least one liquid crystal compound and a chiral dopant in an uncured precursor for the polymer composite between the pair of opposing electrodes; polymerizing the liquid crystal and polymer composite in the presence of an external electrical field in the range of about 50 mV/μm to about 50 V/μm at 60 Hz, wherein the liquid crystal compound(s) and the chiral dopant form cholesteric liquid crystals and removing the external electrical field after curing, wherein the cholesteric liquid crystals re-orient to a focal conic scattering state. In some methods, the polymerization of the reactive mesogen composition can form a polymer network within the cured polymer composite. In some methods, the polymer network can align parallel to the applied external electrical field. It is believed that the addition of a polymer network within the liquid crystal and polymer composite creates an effective alignment field that aligns the liquid crystals in a parallel orientation with the polymer network, thus resulting in a transparent state. To switch the liquid crystal orientation from a transparent state to an opaque focal conic scattering state, the applied electrical field is usually greater than the polymer network's effective alignment field. It is believed that in the present disclosure, the concentration of the reactive mesogen is just below a critical concentration, where during polymerization with an external electrical field applied, the liquid crystals align in a parallel fashion with the polymer network, but when the external electrical field is removed, after polymerization, the polymer networks effective alignment field is not substantial enough to anchor the liquid crystals in an unwound parallel (transparent) state, thus the liquid crystals return to their relaxed focal conic scattering (opaque) state. It is also believed that by holding the reactive mesogens concentration to just below this critical threshold, the present shutter device achieves very low power consumption. In some embodiments, the method includes the concentration of the at least one reactive mesogen as being between about 0.1 wt % to about 40 wt %, wherein wt % is based on the total weight of the polymerizable precursor mixture. In some embodiments, the method describes a light shutter wherein the voltage to effect transparency is less than 3 V/μm at a frequency less than 60 Hz. Some of the methods disclosed herein describe a light shutter that can have an RC time constant (τ) of about 50-70 minutes or about 60 minutes. Other methods include light shutters that can comprise slow discharge capacitors. It is believed that the addition of alignment layers, as described herein, to the light shutter helps maintain an internal electrical charge. It is further believed that due to the alignment layers the light shutter operates similarly to a slow discharge capacitor. It is still further believed that the function of a slow discharge capacitor helps maintain the device in a semi-stable transparent state indefinitely with the assistance of reverse polarity pulsing of a DC electric field. It is also believed that due to the reverse polarity pulsing, the light shutter does not exhibit image sticking issues that are associated with other devices and helps lower the overall power consumption of the light shutters of the present disclosure. In some embodiments, the method includes a light shutter that can consume about 0.037 W/m² at 3V/μm at less than 60 Hz of AC field.

In some embodiments, the method comprises the preparation of any of the aforedescribed light shutters.

The light shutters described herein are useful in methods for controlling the amount of light and/or heat passing through a window. The light shutters described herein may further be useful in efforts to provide privacy, reduce heat from ambient sunlight, and control harmful effects of ultraviolet light.

Hereinafter, exemplary embodiments and methods will be described in more detail.

### Embodiments

Embodiment 1 A light shutter comprising:
a pair of opposing transparent electrodes defining an electrode plane;
a polymer composite comprising a liquid crystal in a focal conic state and a polymer network comprising plural polymer networks aligned perpendicular to the transparent electrode plane, the polymer composite disposed between and in electrical communication with the transparent electrodes, the polymer composite comprising at least one liquid crystal compound, a chiral dopant and at least one reactive mesogen composition; wherein the application of an electric field to the liquid crystal and polymer composite switches the focal conic state liquid crystal configuration to a homeotropically aligned transparent state liquid crystal configuration.
   Embodiment 2 The light shutter of embodiment 1, wherein the focal conic state liquid crystal has a cholesteric pitch of about 0.38 μm to half of the length of dimension between the pair of opposing transparent electrodes.
   Embodiment 3 The light shutter of embodiment 1, wherein the reactive mesogen composition comprises at least one reactive mesogen and a photo-initiator.
   Embodiment 4 The light shutter of embodiment 1, further comprising a power source in electrical communication with the transparent electrodes.
   Embodiment 5 The light shutter of embodiment 1, further comprising at least one alignment layer.
   Embodiment 6 The light shutter of embodiment 1, further comprising at least one dielectric layer.
   Embodiment 7 The light shutter of embodiment 6, wherein the at least one dielectric layer comprises a transparent inorganic material.
   Embodiment 8 The light shutter of embodiment 1, wherein the light shutter has a RC time constant (τ) of about 60 minutes.
   Embodiment 9 The light shutter of embodiment 1, wherein the light shutter maintains a transparent state due to periodic application of short (less than 1 second) opposite polarity DC pulses.
   Embodiment 10 The light shutter of embodiment 1, wherein the light shutter consumes about 0.037 W/m² at 3 V/μm and at frequencies below 60 Hz AC.
   Embodiment 11 The light shutter of embodiment 1, wherein the transparent state is maintained by an external electric field.
   Embodiment 12 The light shutter of embodiment 1, wherein the light shutter maintains a transparent state for up to 40 minutes with an internally stored electric field.
   Embodiment 13 The light shutter of embodiment 1, wherein the at least one liquid crystal compound is a positive dielectric anisotropy liquid crystal compound.
   Embodiment 14 The light shutter of embodiment 1, wherein the light shutter functions as a slow discharge capacitor.
   Embodiment 15 The light shutter of embodiment 1, wherein the concentration of the at least one reactive mesogen is between about 0.1 wt % to about 40 wt %.
   Embodiment 16 The light shutter of embodiment 1, wherein the amount of voltage sufficient to effect transparency is less than 3 V/μm at frequencies below 60 Hz AC.
   Embodiment 17 A method for making a light shutter comprising:
   determining the content of reactive monomer in a precursor liquid crystal formulation at a level below a critical concentration that depends on the cholesteric liquid crystal pitch length and average cross-section (radius) of polymer network fibers;
   disposing a reactive mesogen composition, at least one liquid crystal compound and a chiral dopant in an uncured polymer composite between a pair of transparent opposing electrodes;
   polymerizing the liquid crystal and polymer composite in the presence of an external electrical field in the range of about 50 mV/μm to about 50 V/μm at 60 Hz, wherein the at least one liquid crystal compound and the chiral dopant form cholesteric liquid crystals; and
   removing the external electrical field after curing, wherein the cholesteric liquid crystals re-orients to a focal conic scattering state.
   Embodiment 18 The method of embodiment 18, wherein the polymerizing of the reactive mesogen includes forming a polymer network within the cholesteric liquid crystal environment.
   Embodiment 19 The method of embodiment 18, wherein forming of the polymer network includes aligning the polymer networks parallel to the applied external electrical field.
   Embodiment 20 The light shutter of embodiment 1, further comprising about 0.01 wt % to about 2.0 wt % of ion-trapping nanoparticles to the precursor liquid crystal/reactive mesogen mixture; wherein the ion-trapping nanoparticles comprise NiO and TiO₂; and wherein the addition of the nanoparticles maintains low power consumption and operating stability of the light shutter.

### Examples

It has been discovered that embodiments of the polymer networked liquid crystal light shutter described herein have improved performance as compared to other forms of light shutters. These benefits are further demonstrated by the following examples, which are intended to be illustrative of the disclosure only but are not intended to limit the scope or underlying principles in any way.

### Creation of Polymerizable Liquid Crystal Mixtures PLC-1 Through PCL-5:

For PLC-1, a mixture of 87.5 parts (wt %) of nematic liquid crystal material MLC-2132 (Millipore Sigma Inc. Burlington, Mass., USA), 7.8 parts (wt %) of the chiral dopant R-811 (Millipore Sigma), 4.7 parts (wt %) of the polymerizable reactive mesogen composition (99 parts LC242 (Millipore Sigma), 1 part UV photo-initiator IrgaCure® 651 (Ciba Specialty Chemicals, Inc., Basel, Switzerland) was mixed in a 100 mL glass flask. The syrup was heated to just above the clearing point and mixed using a vortex mixer to form a homogeneous mixture. Next, this mixture was degassed at room temperature (RT) to ensure that excess air exits the mixture.

The formulating process was repeated for the additional mixtures PLC-2 through PLC-5 with the exception that the mass ratios of the constituents were varied as shown in Table 1.

### Creation of Polymerizable Liquid Crystal Mixture PCL-6:

For PLC-6, the procedure for PLC-1 (above) was followed, in accordance with the materials of PLC-3, further incorporating the addition of a mixture of nickel (NiO) and titanium (TiO₂) nanoparticles to the final syrup in an amount of 0.05 wt % each prior to vortex mixing. The nickel and titanium nanoparticles were added for the purpose of trapping ions to maintain high resistivity of the liquid crystal and therefore keep power consumption low throughout the operating lifetime of the device. The TiO₂ nanoparticles employed have 5 nm diameter and the NiO nanoparticles employed have 10-20 nm diameter. Both types of nanoparticles were purchased from US Research Nanomaterials.

TABLE 1
Mixture Formulations

| | | | Polymerizable | | |
|---|---|---|---|---|---|
| | Liquid | | Reactive Mesogen | | |
| | Crystal | | Composition (wt %) | | |
| | (wt %) | Chiral | Reactive | UV | |
| | MLC- | Dopant | Mesogen | Photoinitiator | |
| | 2132 | (wt %) | LC242 | IrgaCure 651 | Dielectric |
| Formulation | (wt %) | R-811 | 99 parts | 1 part | Layer |

| | | | | |
|---|---|---|---|---|
| PLC-1 | 87.5 | 7.8 | 4.7 | None |
| PLC-2 | 86.8 | 8.5 | 4.7 | SE-4811 |
| PLC-3 | 87.5 | 7.8 | 4.7 | SE-6551 |
| PLC-4 | 87.5 | 7.8 | 4.7 | SiOₓ |
| PLC-5 | 87.5 | 7.8 | 4.7 | Al₂O₃ |
| PLC-6* | 87.5 | 7.8 | 4.7 | SE-6551 |

*NiO (0.05 wt %) and TiO₂ (0.05 wt %) also added prior to mixing.

### Fabrication of Polymer Network Liquid Crystal Light Shutter:

ITO glass substrates (3.00 inches×3.00 inches, Thin Film Devices, Anaheim, Calif., USA) can be obtained directly from the manufacturer. Alternatively, an ITO electron conduction layer may be fabricated on a glass surface to yield a conductive substrate. The ITO substrates were cleaned from dust particles by streaming pressurized nitrogen gas over the surface and then examined under reflected light to ensure that no visible dust particles remained. If an alignment layer was used in the sample, the ITO substrate was placed with the ITO coated surface face up on spin coater (Mikasa Spin Coater 1H-DX2, Mikasa Co. Led., Tokyo, Japan). The alignment layer, without dilution, was coated onto the ITO substrate using a setting of 2,000 rpm for 20 seconds. On one of the ITO substrates, 10 μm NanoMicro HT100 microsphere spacers are incorporated into the alignment layer, at about 0.25 wt % with respect to the weight of alignment layer and coated onto ITO surface. Next, the coated substrates were placed on a metallic plate which were then placed directly onto the oven racks, to ensure even heat transfer to the substrates and baked to cure the alignment layers at temperatures and durations recommended by manufacturer.

For examples where there is a dielectric layer, the dielectric layers were sputtered directly over the conducting ITO layer on the substrate. Sekisui SP210 spacers were mixed in 2-propanol at 1 wt % and then wet sprayed using a hand-held Preval Sprayer (Chicago Aerosol, Coal City, Ill.) to yield a surface density of approximately 100 spacers/mm² on the surface of the dielectric layer. Next, the coated substrates where allowed to dry for 5 minutes at room temperature, leaving only the spacers dispersed over the entire surface.

Next, the prepared substrates, one including spacers and the other one without spacers, were placed on top of each other, such that the ITO surfaces were in opposition forming an air gap of about 10 μm. Four paper clips were then fastened to the four corners to keep the substrates together. Next, substrate stack (cell) was preheated by soft baking the substrates at 100° C. for 5 minutes on a hot plate. Then, the polymerizable liquid crystal mixture was capillary filled into the air gap. The filled cell was then cooled at room temperature. The excess polymerizable liquid crystal mixture was removed by pushing on the active area of the cell to avoid cell gap distortions.

The assembly was irradiated with a UV light illumination (Larson Electronics Co., model DCP-11-DP, Kemp, Tex., USA) with intensity of 15 mW/cm² for 15 minutes. During curing an AC voltage of 60 V and 60 Hz was maintained, which was approximately two times higher than the voltage necessary to completely align liquid crystals homeotropically and induce the transparent state. After curing and removing the external voltage, the device returned back to an opaque light scattering state because the concentration of reactive mesogens is chosen just below the critical concentration.

After UV-curing, the edges can be sealed with a sealant (e.g., NOA68 UV glue) to protect the liquid crystal element. The cell was cured for 1 hour to harden the glue, under the same UV illumination with the active area of the device covered with aluminum foil.

Afterwards, both substrates of the polymer networked liquid crystal light shutter can be electrically connected by soldering wires to the ITO terminals such that each conductive substrate are in electrical communication with a voltage source, where the communication is such that when the voltage source is applied an electric field will be generated across the device. The voltage source will provide the necessary voltage across the device to enable the switching to the transparent state.

### Optical (Haze) Measurements:

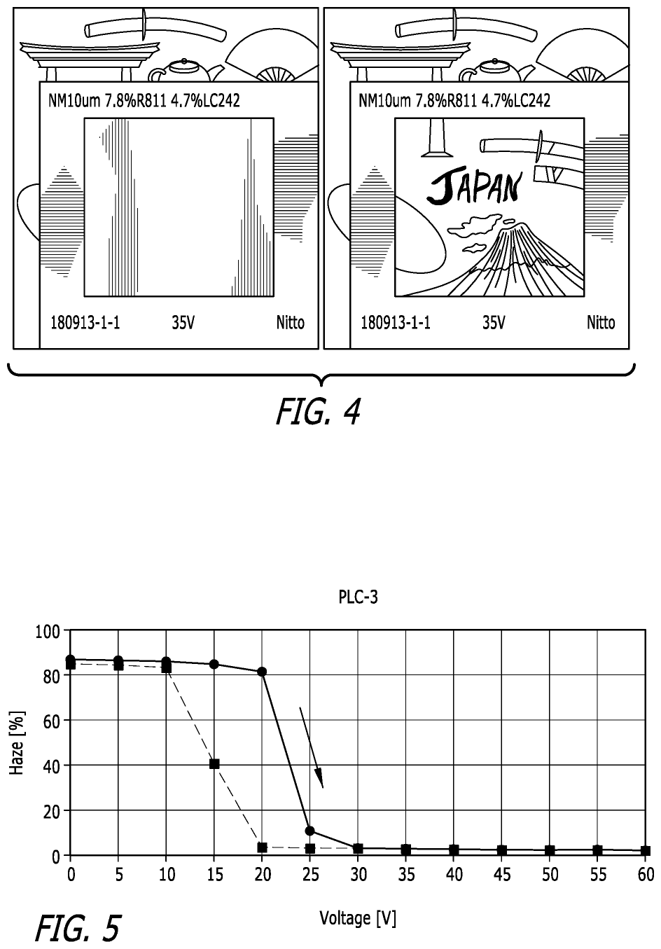

The optical characteristics of the light shutters were characterized by measuring the light allowed to pass through each fabricated shutter, both with and without an electric field present, see FIG. 4 for representative image of a device in its opaque and transparent state. Light transmittance data for the samples was measured using a haze meter (Nippon Denshoku NDH 7000; NDK, Japan) with each respective sample placed inside the device. The source was directly measured without any sample present to provide a baseline measurement of total light transmitted. Then, the samples were placed directly in the optical path, such that the emitted light passes through the samples. Then the sample, connected to a voltage source (3PN117C Variable Transformer; Superior Electric, Farmington, Conn., USA) via electrical wires, one wire connected to each terminal and to a respective ITO glass substrate on the device such that an electric field would be applied across the device when a voltage source is energized, or a voltage applied, was placed into the haze meter. Then, the emitted light transmitted through the samples was measured, at first with no voltage applied and then again at various magnitudes of voltage, ranging from 0 volts up to 60 volts with measurements taken at 5 volt increments; with haze measurements taken at differing times. See FIG. 5 for representative example of a measured curve of the haze level against applied voltage.

### Power Consumption Measurements:

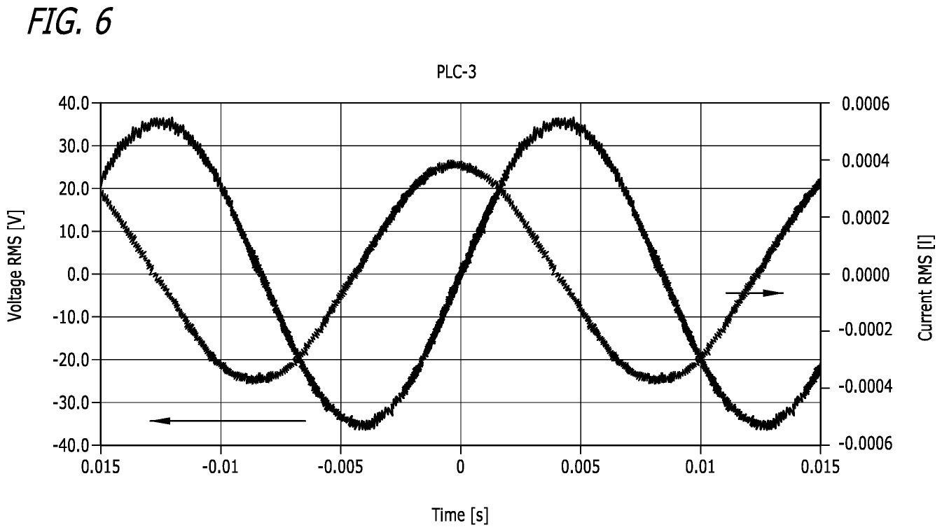

Power consumption P was determined by measuring the amplitude of the applied voltage V_{R}ms to the light shutter, the resulting current amplitude IRMS passing through the shutter and the phase shift θ between the voltage and current. Power consumption is calculated by P=V_{RMS}*I_{RMS}*Cos(θ). See FIG. 6 for representative example of measured voltage and current signals necessary to determine power consumption.

The results for the measurements are summarized in Table 2 (and presented in FIG. 5 for PLC-3).

TABLE 2
Summary of Haze Measurements:

| Device | % Haze Transparent | % Haze Opaque |
|---|---|---|
| PLC-1 | 2 | 88 |
| PLC-2 | 2 | 85 |
| PLC-3 | 2 | 85 |
| PLC-4 | 3.70 | 86.5 |
| PLC-5 | 3.63 | 87.3 |
| PLC-6 | 2 | 87 |

While the present disclosure has been shown and described in connection with the embodiments, it will be apparent to those skilled in the art that modifications and variations can be made without departing from the spirit and scope of the disclosure as defined by the appended embodiments.

The terms “a”, “an”, “the” and similar referents used in the context of describing the present disclosure (especially in the context of the following claims) are to be construed to cover both the singular and the plural, unless otherwise indicated herein or clearly contradicted by context. All method described herein can be performed in any suitable order unless otherwise indicated herein or contradicted by context. The use of any and all examples or exemplary language (e.g., “such as”) provided herein is intended merely to better illuminate the disclosure and does not pose a limitation on the scope of any claim. No language in the specification should be construed as indicating any non-claimed element essential to the practice of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience.

Certain embodiments are described herein, including the best mode known to the inventors for carrying out the disclosure. Of course, variations on these described embodiments, will become apparent to those or ordinary skill in the art upon reading the foregoing description. The inventor expects skilled artisans to employ such variations as appropriate, and the inventors intend for the present disclosure to be practiced otherwise than specifically described herein. Accordingly, the claims include all modifications and equivalents, or the subject matter recited in the claims as permitted by applicable law. Moreover, any combination of the above described elements in all possible variations thereof is contemplated unless otherwise indicated herein or otherwise clearly contradicted by context.

In closing, it is to be understood that the embodiments disclosed herein are illustrative of the principles of the claims. Thus, by way of example, but not limitation, alternative embodiments may be utilized in accordance with the teachings herein. Accordingly, the claims are not limited to embodiments precisely as shown or described.

1. A light shutter comprising:
a pair of opposing transparent electrodes defining an electrode plane;
a polymer composite comprising a liquid crystal in a focal conic state and a polymer network comprising plural polymer network domains aligned perpendicular to the electrode plane, the polymer composite disposed between and in electrical communication with the transparent electrodes, the polymer composite comprising at least one liquid crystal compound, a chiral dopant and at least one reactive mesogen composition; and
wherein application of an electric field to the polymer composite switches the liquid crystal from a focal conic state to a homeotropically aligned transparent state.

2. The light shutter of claim 1, wherein the focal conic state liquid crystal has a cholesteric pitch of about 0.38 μm to about half of the length of the gap between the pair of opposing transparent electrodes.

3. The light shutter of claim 1, wherein the reactive mesogen composition comprises at least one reactive mesogen and a photo-initiator.

4. The light shutter of claim 1, further comprising a power source in electrical communication with the pair of opposing transparent electrodes.

5. The light shutter of claim 1, further comprising at least one alignment layer.

6. The light shutter of claim 1, further comprising a dielectric layer, wherein the dielectric layer comprises a transparent inorganic material.

7. (canceled)

8. The light shutter of claim 1, wherein the light shutter has a RC time constant (τ) of about 50 minutes to about 70 minutes.

9. The light shutter of claim 1, wherein the light shutter maintains a transparent state due to periodic application of opposite polarity DC pulses.

10. The light shutter of claim 1, wherein the light shutter consumes about 0.03 W/m² to about 0.04 W/m² at 3 V/μm below a frequency of 60 Hz AC.

11. The light shutter of claim 1, wherein the transparent state is maintained by an external electric field.

12. The light shutter of claim 1, wherein the light shutter maintains a transparent state for at least about 30 minutes with an internally stored electric field.

13. The light shutter of claim 1, wherein the at least one liquid crystal compound is a positive dielectric anisotropic liquid crystal compound.

14. The light shutter of claim 1, wherein the light shutter functions as a slow discharge capacitor.

15. The light shutter of claim 1, wherein the concentration of the at least one reactive mesogen is between about 0.1 wt % to about 40 wt %.

16. The light shutter of claim 1, wherein the amount of voltage sufficient to effect transparency is less than 3 V/μm below a frequency of 60 Hz AC.

17. The light shutter of claim 1, wherein the polymer network further comprises about 0.01 wt % to about 2.0 wt % of ion-trapping nanoparticles; wherein the ion-trapping nanoparticles comprise NiO and TiO₂; and wherein the addition of the ion-trapping nanoparticles maintains low power consumption and operating stability of the light shutter.

18. A method for making the light shutter of claim 1 comprising:
disposing a reactive mesogen composition, at least one liquid crystal compound and a chiral dopant in an uncured polymer composite between a pair of opposing transparent electrodes;
polymerizing the polymer composite to form the polymer network in the presence of an external electrical field in the range of about 50 mV/μm to about 50 V/μm at 60 Hz, wherein the at least one liquid crystal compound and the chiral dopant form cholesteric liquid crystals; and
removing the external electrical field after curing, wherein the cholesteric liquid crystals re-orientates to a focal conic scattering state.

19. The method of claim 18, wherein the polymer network further comprises ion-trapping nanoparticles, wherein the ion-trapping nanoparticles comprise NiO and TiO₂.

20. The method of claim 18, wherein the polymerizing of the reactive mesogen includes forming a polymer network within the cured polymer composite.

21. The method of claim 18, wherein forming of the polymer network includes aligning the polymer network parallel to the applied external electrical field.
